(19) United States
(12) Patent Application Publication
(10) Pub. No.: US 2003/0036048 A1
(43) Pub. Date: Feb. 20, 2003

(54) Tracing device

(76) Inventor: Eugene Gaster, Madison, OH (US)

Correspondence Address: Reuben Wolk, Esq., 3849 Seiber Avenue, Dayton, OH, 45405, US

(21) Appl. No.: 09/732,095

(22) Filed: Dec. 8, 2000

(51) Int. Cl. G09B 11/04

(52) U.S. Cl. 434/404

(57) ABSTRACT

A tracing device having a closed housing including a transparent or translucent upper member with an outer planar surface. Transparent or translucent discs are mounted on the planar surface in spaced planar relationship, each having a different set of symbols. The discs may be rotated to expose selected symbols of each set into selected relationship with each other. A transparent or translucent cover is placed over the discs and supports a sheet of material upon which the selected symbols are traced.

### BACKGROUND OF THE INVENTION

This invention relates to a device for tracing selected symbols onto a sheet of material such as paper, fabric or plastic, for creating a large variety of distinctive combinations.

### PRIOR ART STATEMENT

It is known to trace various symbols such as letters, numbers, objects or pictures, onto sheets of material such as paper, for the purpose of education or enjoyment. The simplest system which has been used by children for many years, for example, is the placement of a sheet of semi-transparent paper over a comic strip or a picture in a book, and trace the object onto the sheet. A similar technique has been commonly used to trace letters, numbers, words or pictures to form part of a student's school report, or part of a business document. This technique has been further expanded to form bizarre characters by placing dissimilar characters in selected positions so that different parts of these items may be traced on a common tracing medium. Enhancement of the items may be provided by the use of an artificial light source under the items to be traced. Typical devices are shown, for example, in U.S. Pat. No. 4,427,387, issued to Tomita; and U.S. Pat. No. 4,600,393, issued to Rosenwinkel. These patents provide for longitudinal passage of figures over a light source under a translucent platen on which a sheet of paper is placed so that the tracing may be made. The Tomita patent permits different portions of a doll's body to be displayed so that different composite doll figures may be created. Another approach is shown in U.S. Pat. No. 1,558,041 for placing a base sheet having comic heads upon a central supporting member. A concentric translucent sheet is mounted on the base sheet and contains facial features such as eyes, ears, nose, etc. By rotating the superimposed sheet, desired facial features are aligned (or deliberately misaligned) with the comic heads. An outer sheet of tracing paper is placed over the two sheets to trace the aligned heads and features to provide a desired finished picture.

### SUMMARY OF THE INVENTION

The present invention relaters to a device which greatly enhances the concept of tracing by selectively providing symbols, which term is meant herein to refer to any item or object including but not limited to figures, numbers, letters, words, buildings, plants or flowers, animals, vehicles. This is accomplished by placing two or more translucent or transparent plastic discs in spaced planar relationship on a planar surface, each disc containing a different set of symbols, and providing a light source to illuminate the symbols. By rotating the discs around a central pivot point on the planar surface, any desired symbol on each disc may be rotated to the central part of the planar surface into a desired relationship. A cover having a transparent or translucent window area is placed over the discs so that the selected symbols may be traced on a sheet of material supported on the cover. The tracing sheet may be paper, plastic, or fabric. The device is compact and easy to transport, assemble and disassemble. One example of the symbols placed on two of the discs is a facial outline on one and facial features on another, as will be illustrated herein and described below.

It is a principal object of this invention to provide a device for tracing a large number of combinations of selected symbols on a tracing sheet.

It is a further object to provide a simple system of placing different types of symbols in registration so that they may be easily traced.

It is another object of the invention to provide for simple assembly and disassembly of the device.

It is another object to provide a device which is compact and easily transported.

These and other objects will become apparent from the embodiment illustrated and described herein.

### BRIEF DESCRIPTION OF THE DRAWINGS

FIG. 1 is a partially exploded perspective view of the novel device assemble for tracing.

FIG. 2 is a perspective view of the novel device showing a typical tracing procedure.

FIG. 3 is sectional view of the device taken along lines 3-3 of FIG. 2.

FIGS. 4-6 are top views of three of the typical discs which may be used.

### DESCRIPTION OF THE PREFERRED EMBODIMENT

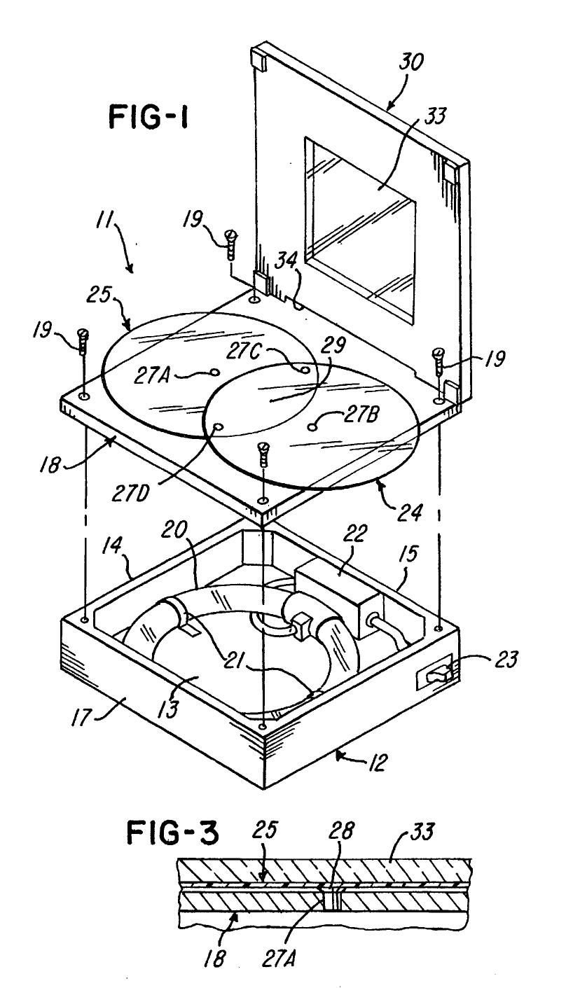

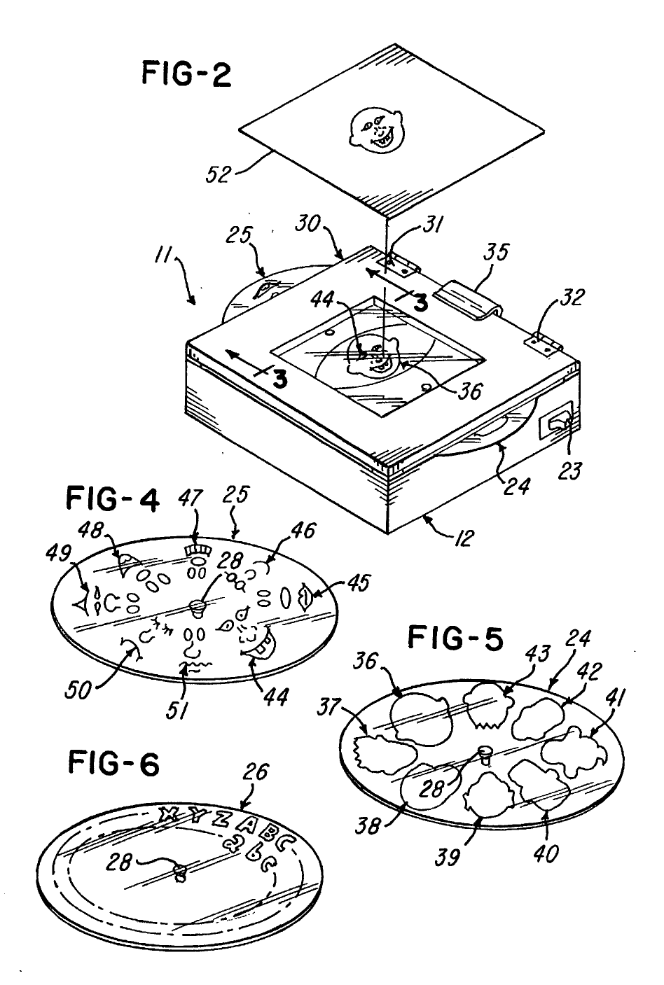

Referring to FIGS. 1 and 2, the novel device 11 consists of a box-like housing 12 having a bottom member 13, vertical sides 14, 15 16 and 17, and an upper member 18 having a planar upper surface. The housing may be made of a rigid plastic, metal or wood, except for the member 18, which is made of a transparent or translucent plastic such as methyl methacrylate, frequently sold under the trademark LUCITE; or acrylic materials such as PLEXIGLASS. The member 18 is secured to the sides of the housing by screws 19 which are flush mounted to the outer surface of member 18. A light source consisting of a fluorescent bulb 20 is mounted on the bottom and secured by clips 21. Batteries 22 are wired to the bulb in a manner which is well-known, through a conventional on-off switch 23 mounted on the side 14 of the housing, thus used to activate the light when the device is in use. Other types of lighting may be used, such as by directly wiring to a 110 volt power source, or by using incandescent lights. However, fluorescent lighting is preferred because the internal build up of heat is reduced.

The tracing members preferably utilized in the present device consist of transparent or translucent circular discs 24 and 25, such as shown in detail in FIGS. 4-6. These are approximately 10 inches in diameter and about 1/32 inch thick, and made of a material similar to that of member 18. The symbols shown in the drawings may be applied by conventional methods, such as silk-screening, embossing, stamping or printing. Any of these methods which bring out the symbols in a highly visual manner may be utilized. The desired discs which contain the various sets of symbols are mounted at their central points on the upper (outer) surfaces of member 18. In the FIGS. 1 and 2 showing. Two discs 24 and 25 are mounted, but in operation it is possible to mount four such discs at the same time. Mounting is accomplished by forming circular holes 27A, 27B, 27C and 27D in spaced planar relationship on the outer surface of member 18 as shown; and by placing circular knobs 28 on the on the inner surfaces of the discs which are inserted into the holes. This is shown in section in FIG. 3. When so mounted, the discs may be rotated by hand so that the desired symbol on each disc is exposed in the central area 29 of the surface 18. The discs 24 and 25 are shown mounted in holes 27A and 27B, and if the other discs are to be placed in operation, they are mounted in holes 27C and 27D. A flat cover 30, made of material similar to that of the housing, is placed over the member 18, as shown in FIGS. 1 and 2, and is attached by hinges 31 and 32. A window 33 is placed in the center of the cover, and is formed of a transparent or translucent material similar to that of member 18, so that the symbols selected from the discs may be visible. This window is flush with the surfaces of the rest of the cover. A cutout portion 34 is located in the edge of the cover which is secured to the member 18 on order to permit the disc which may be placed on the hole 27C. The cover has a clamp 35 of any preferred design, which is used to secure the sheet of tracing material 52 which is placed over the cover.

Operation of the Device

In the typical operation shown in FIGS. 1 and 2, the cover 30 is raised and discs 24 and 25 are mounted so that the knobs 28 thereof are inserted into holes 27A and 27B. The cover is then closed and the discs rotated by hand to a desired position. The cover is designed so that the discs are held loosely against the member 18, but tightly enough so they cannot turn or rotate of their own volition. To achieve the tracing of FIG. 7, the disc 24, containing symbols representing a set of facial outlines 36-43, is rotated around the central members 27A and 28 so that the symbol 36 is placed within the central area 29, and is also visible in the window area 33 of the cover. The disc 25, containing a set of facial features 44 to 51, is similarly rotated so that the feature 44, consisting of eyes, a nose, and a snaggle-tooth mouth, appears within the outline of the face. The user then places a sheet of paper 52 over the window of the cover, securing it with the clamp 35, and traces the symbols 36 and 44 on the paper. Discs 23 and 24 are shown in greater detail in FIGS. 4 and 5. The user is then ready for another operation if he so desires. For example, a third disc may contain set of different hats, and a fourth disc may contain a set of neckties, so that a more complete head may be drawn. The user then removes the paper and is ready for another operation.

To provide some idea of the versatility of the device and method, a disc 26, shown in FIG. 6, may contain a set of letters of the English alphabet, both upper and lower case. It is contemplated that this disc may be used in conjunction with another disc containing letters of a different alphabet, such as Russian or Greek, thus providing a learning aid for students. Other discs may contain such symbols as numbers, parts of autos or airplanes, buildings, flowers, or any other objects within the human ken. As used herein, term “symbol” applies to any of the traceable items referred to herein. In addition to tracing on paper as shown, fabric material, such as used on T-shirts, may be used in order to create a personalized product. Further, tracing may be made on sheets of plastic material to be used for decorative purposes.

The above embodiment shown and described herein is merely exemplary. Further modifications may be made within the spirit of the invention.

I claim:

1. In a tracing device comprising a closed housing having a transparent or translucent upper member with an outer planar surface; the improvement comprising a plurality of transparent or translucent tracing members mounted on said planar surface in spaced planar relationship, each of said tracing members having a different set of symbols theron, a cover having a transparent area for supporting a tracing sheet placed thereover, and means for moving said tracing members while retaining said spaced planar relationship to arrange selected ones of said symbols of each of said tracing members in visual relationship with each other, whereby said selected symbols may be traced upon said sheet.

2. The device of claim 1 wherein said tracing members comprise circular discs and said means for moving said tracing members comprises means for rotation of said discs to desired positions.

3. The device of claim 2 wherein said planar surface includes means for securing said discs, each of said discs having attaching means centrally located on its lower surface for attaching to said securing means.

4. The discs of claim 3 wherein said securing means comprises openings on said planar surface, and said attaching means comprises protuberances engaging said openings.

5. The device of claim 2 wherein said discs are retained between said cover and said upper planar surface in a manner allowing rotation of said discs.

6. The device of claim 1 further comprising a light source in said housing for transmitting light through said symbols whereby said symbols are visible on said sheet.

7. The device of claim 1 comprising means for raising and lowering said cover over said planar surface to permit insertion and removal of said tracing members.

8. The device of claim 7 wherein said cover is hinged to said upper member.

9. The device of claim 1 wherein said sheet is selected from the group consisting of paper, fabric and plastic sheet.

10. The device of claim 1 wherein one said of symbols comprises outlines of character faces, and another set of symbols comprises segments of facial features related to any of said faces.

11. A method of tracing symbols on a sheet comprising the steps of providing a closed housing having a transparent or translucent upper member having an outer planar surface, mounting a plurality of transparent or translucent tracing members each having a different set of symbols thereon in spaced planar relationship on said planar surface, placing a cover having a transparent or translucent area over said planar surface for supporting said sheet, moving said tracing members to arrange selected symbols on each tracing member in visual relationship with each other to display said symbols through said cover.

12. The method of claim 11 comprising the further step of placing said sheet over said cover, and tracing said displayed symbols onto said sheet.

13. The method of claim 11 comprising the further steps of forming said tracing members in the shape of circular discs, and rotating said discs to desired positions.

14. The method of claim 13 comprising the further steps of providing securing means on said planar surface for securing said discs, and providing attaching means on the surface of said discs for attaching to said securing means.

15. The method of claim 11 comprising the further steps of providing a light source in said housing, and transmitting light from said source through said tracing members to illuminate said symbols for tracing upon said sheet.

16. The method of claim 11 comprising the further step of hinging said cover to said upper member to enable insertion and removal of said tracing members.
